(19) United States
(12) Patent Application Publication
(10) Pub. No.: US 2009/0237029 A1
(43) Pub. Date: Sep. 24, 2009

(54) INDUCTIVE BATTERY CHARGER FOR SERVICE EQUIPMENT

(75) Inventor: Richard ANDELFINGER, Chandler, AZ (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: SPX Corporation, Charlotte, NC (US)

(21) Appl. No.: 12/054,044

(22) Filed: Mar. 24, 2008

(51) Int. Cl. H02J 7/04; H02J 7/00

(52) U.S. Cl. 320/108; 320/115

(57) ABSTRACT

An inductive battery charging system for a handheld service tool is provided. The system includes a battery charger and a handheld service tool. The battery charger has a primary coil enclosed within a housing, and which is coupled to a power source. The service tool includes a secondary coil, enclosed within a housing, that provides at least 100 mA of inductively-generated alternating current, a rectifier, a linear voltage regulator, a battery charge controller and a battery.

### FIELD OF THE INVENTION

The present invention relates generally to an inductive battery charger for a portable handheld device such as a battery tester or an automotive scanner.

### BACKGROUND OF THE INVENTION

Automotive service equipment must exist in a high-risk environment with numerous sources of contamination, dirt, chemical solvents, etc., which can all easily corrupt electrical connectors intended to recharge battery-powered equipment. Additionally, use of the equipment in a garage or shop environment will frequently subject it to unintentional physical abuse (by dropping the equipment or having tools dropped upon it) that can damage or destroy electrical connectors and associated wiring. A purely inductive charging system would allow for recharging suitable battery systems without an external connector, eliminating a high-probability source of potential failure, while providing better service time and reduced warranty issues.

It is believed that there are no automotive service tools known to incorporate an inductive charging scheme such as described herein, wherein the primary portion of the charger is situated in a storage unit or base station and wherein electrical (ohmic) contacts are not required to transfer energy for the charging circuitry. Current service tools typically require a wired connection involving a plug and a socket to make electrical contact for the purpose of charging the internal batteries. This connection is subject to breakage, contamination with fluids, grease and dirt, and poor or reduced performance due to oxidation of the electrical contacts as set forth above. It is also susceptible to inadvertent damage caused by, for example, the end-user connecting the wrong recharging power supply to the instrument.

Accordingly, it is desirable to provide an inductive battery charger that addresses these shortcomings, particularly within the vehicle service tool market. Advantageously, such an improved charged instrument may be used for a significant length of time before recharging, and would provide a convenient storage location for the service tool.

### SUMMARY OF THE INVENTION

The foregoing needs are met, to a great extent, by the present invention, wherein in one aspect an apparatus is provided that in some embodiments provides for automatic recharging without operator effort in harsh environments, making the engaged service tool always available and fully charged, and eliminating the need to purchase disposable batteries. The inductive battery charger of the present invention may be advantageously retrofitted to existing handheld devices, such as battery testers, with minimal internal changes to the electronics and without any plastic housing or case changes.

In accordance with one embodiment of the present invention, an inductive battery charging system for a handheld service tool is provided. The system includes a battery charger and the service tool. The battery charger has a primary coil, enclosed within a housing that is coupled to a power source, while the service tool includes a secondary coil, enclosed within a housing that provides at least 100 mA of inductively-generated alternating current, a rectifier, a linear voltage regulator, a battery charge controller, and a battery.

In accordance with another embodiment of the present invention, an inductively-charged, handheld service tool is provided. The service tool has a housing that encloses a coil that provides at least 100 mA of inductively-generated alternating current, and a rectifier coupled to the coil. The housing also contains a linear voltage regulator coupled to the rectifier, a battery charge controller coupled to the linear voltage regulator, and a battery coupled to the battery charge controller.

In accordance with yet another embodiment of the present invention, a method of inductively charging a handheld service tool is provided. The method includes placing the service tool on a base station that includes a battery charger having a primary coil, and inductively coupling the output of the primary coil to a secondary coil, enclosed within the handheld service tool, to generate an AC waveform. Thereafter, the AC waveform is converted into a pulsating DC signal, the pulsating DC voltage is converted into a steady-state DC signal, and a battery of the handheld service tool is charged using the steady state DC signal. The charging status of the battery is also indicated.

In accordance with still another embodiment of the present invention, an inductive battery system is provided. The system includes a battery charger and a handheld service tool. The battery charger is coupled to a power source and has means for generating an electromagnetic field. The handheld service tool, includes means for inductively-coupling the electromagnetic field to provide at least 100 mA of alternating current, means for charging a battery using the inductively-generated alternating current, and means for housing at least the coupling means and the charging means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1A is a perspective view illustrating a service tool used in accordance with a preferred embodiment of the inductive battery charger.

FIG. 1B is a side view of an exemplary inductive battery charger in accordance with the present invention.

FIG. 2A is a schematic diagram of an AC power supply for an internal primary coil of the inductive battery charger.

FIG. 2B is a schematic diagram of an alternative power supply for the internal primary coil of the inductive battery charger.

FIG. 3 illustrates a diagrammatic representation of circuitry for a secondary coil suitable for carrying out the functions of an embodiment of the invention.

FIG. 4 illustrates an exemplary work bench charger assembly in accordance with an embodiment of the invention.

FIG. illustrates an exemplary wall-mounted charger assembly in accordance with an embodiment of the invention.

FIG. 6 illustrates an exemplary suspension charger assembly in accordance with an embodiment of the invention.

### DETAILED DESCRIPTION

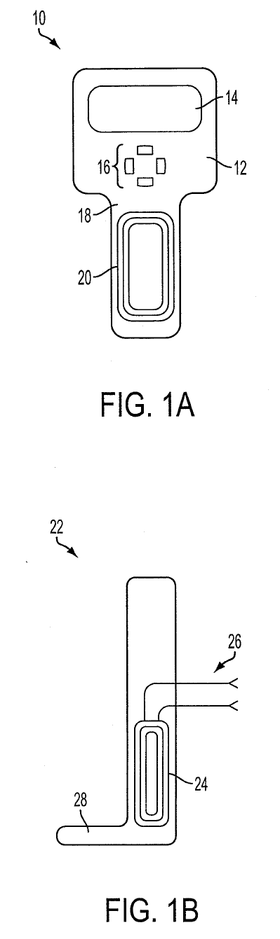

The invention will now be described with reference to the drawing figures, in which like reference numerals refer to like parts throughout. With reference to the drawings, an embodiment in accordance with the inventive inductive battery charger assembly is provided, comprised of a handheld service tool 10 and an inductive battery charger 22, as seen in FIGS. 1A and 1B respectively. The service tool 10 may be a battery tester or automotive scanner used in a vehicle diagnostic and repair facility. The service tool 10 shown in FIG. 1A has a housing 12 containing a display 14, user entry buttons 16, and a handle 18. Enclosed within the body of the handle is an internal secondary coil 20 of wire forming one-half of an AC transformer. This internal secondary coil 20 is connected to a power supply circuit, enclosed within housing 12 that recharges the batteries of the handheld device.

In one embodiment, the housing 12 may be substantially sealed against the adverse effects of the test environment, such as, for example, contamination with fluids, grease, dirt, etc., against poor or reduced performance due to oxidation of the electrical contacts, etc. Similarly, the housing of the inductive battery charger 22 may be substantially sealed against the adverse effects of the test environment. In another embodiment, the housing 12 and the inductive battery charger 22 housing are hermetically sealed, while in a further embodiment, gaskets may be used to seal the seams between the appropriate portions of the housing 12, as well as the seams between the appropriate portions of the inductive battery charger 22 housing, as is known in the art.

A primary coil 24 connected to an AC mains power 26 is provided in an external cradle 28 or surface of the inductive battery charger 22 depicted in FIG. 1B. When the service tool 10 is placed within the cradle 28 or on the surface of the charger 22 for storage and recharge, the coils 20 and 24 form a complete transformer circuit providing power to the battery charging system within the handheld device. The secondary coil 20 inductively couples with the primary coil 24 to accept energy. Proper sizing of the two coils is implemented to support different battery sizes and architectures.

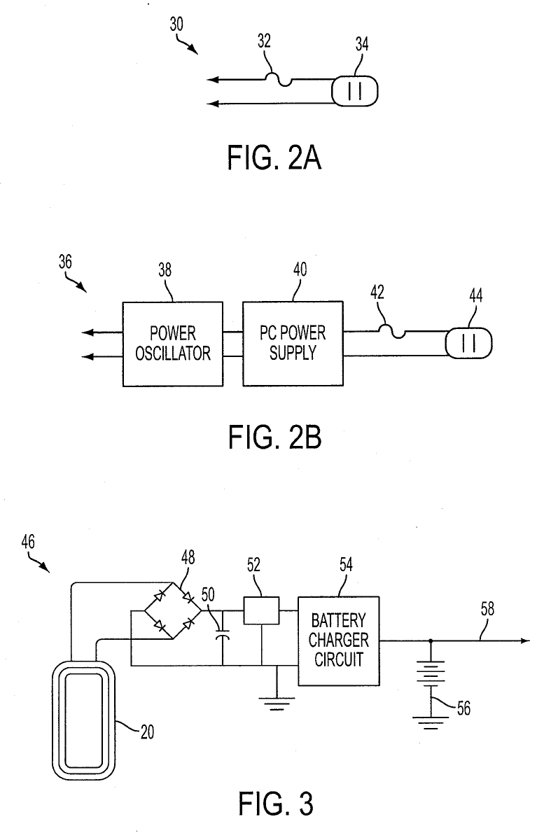

In the preferred embodiment, and with reference to FIG. 2A, the power source 30 of the primary coil 24 is comprised of a direct connection 32 from a plug 34 to an AC line. In another embodiment, a power source 36 is shown in FIG. 2B having an amplified oscillator 38 connected to a DC power supply 40 with a direct connection 42 to a plug 44, which operates the primary coil 24 at a resonant frequency to maximize energy transfer.

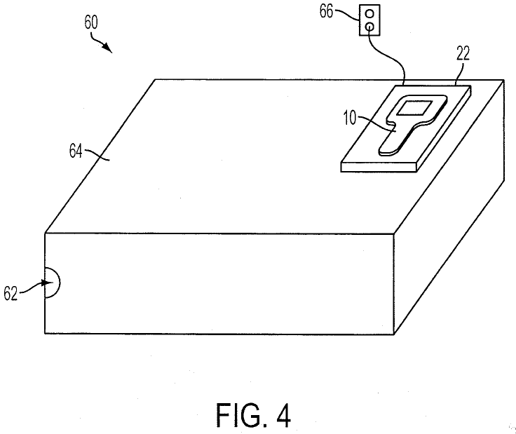

As shown in the FIG. 3B, the secondary coil 20 is sized and wound to provide optimum coupling with the primary coil 24 and has power supply circuitry 46 comprised of a rectifier 48, a capacitor filter 50, and a linear voltage regulator 52 to provide DC power for a battery-charging integrated circuit 54. The secondary coil 20 must be compatible with the frequency provided by primary coil 24, and must have sufficient current capacity to operate the battery-charging integrated circuit 54.

To charge the service tool, the rectifier 48 converts an AC waveform of the secondary coil 24 into pulsating DC. The filter 50 and voltage regulator 52 convert the pulsating DC into steady-state DC. Thereafter, the battery-charging integrated circuit 54 uses the steady-state DC voltage to control the voltage and current presented across a battery pack 56 in order to provide a power connection 58 to the service tool. In accordance with the preferred embodiment, the battery pack 54 is comprised of a set of batteries having capacity and chemistry complimentary to the portable service tool being powered. Accordingly, nickel-metal hydride (NiMH) batteries or lithium ion (Li-Ion) batteries may be used.

A conventional battery-charging integrated circuit 54 having properties including but not limited to charging current control, battery chemistry support, and user status displays may be employed. The integrated circuit 54 (hereinafter “IC”) serves as a controller and provides several functions. The IC 54 charges the battery 56 pack when depleted partially or fully. It maintains a trickle-charge on the battery 56 pack when not in use and prevents the battery from over-discharge. The IC 54 prevents overheating of the battery pack 56 whether the service tool is in use or is recharging. As referenced above, the IC 54 provides an external indicator (located on the service tool) to the user of the current status of the battery charger. Several status indicators are available including “charging”, “charged, ready for use”, and “overheated, waiting for cool-down before charging.” These status indicators may be presented via a single LED utilizing various flashing codes or via multiple LEDs, wherein each status indicator has a different color.

The dimensions for the internal secondary coil 20 in FIG. 1A approximate 4″ in diameter with 1″ of corresponding width, and the primary coil 24 approximates 6″ diameter by 1″ wide. This configuration can provide approximately 100 mA of 11.5V (AC) current for a battery recharging circuit. The secondary coil 20 is the receiver coil in the inductive battery charger assembly. The secondary coil 20 is sized as described herein and wound to provide optimal coupling with the primary coil 24.

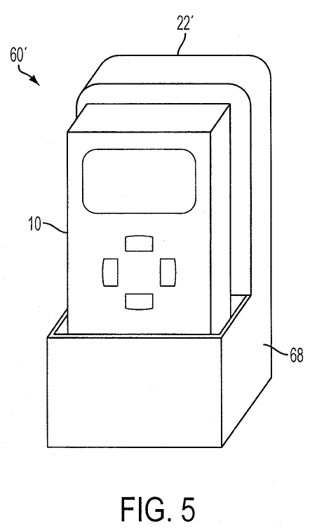

In the preferred embodiment, the inductive battery charger assembly 60, as depicted in FIG. 4 has a base station 62 having a top platform or a flat plate 64. The charger 22 may be placed upon the surface of a workbench, table, toolbox or other work surface. The service tool 10 to be charged is placed upon the charger 22 and stored for future use. The primary coil 24 has a driving voltage of a 60 Hz AC power line connected to plug 66 at 110V or 220V.

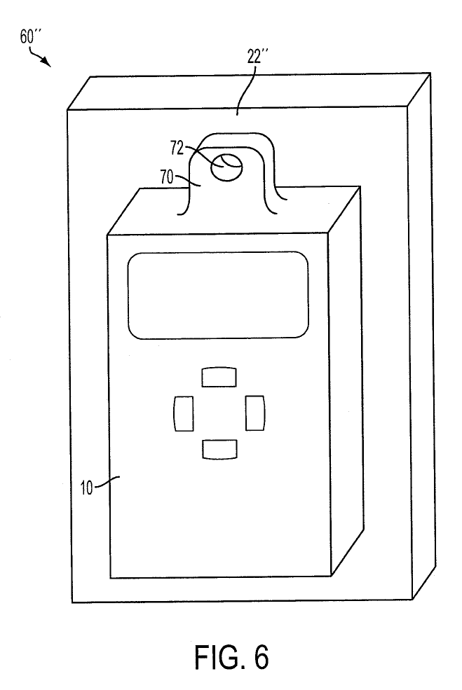

In accordance with an alternative embodiment, the inductive battery charger assembly 60′, as illustrated in FIG. 5, is presented wherein the charger 22′ is a receptacle having a wall-mounted base and a cradle 68. The charger 22′ holds the service tool 10 to be charged in a recess within the cradle 68. With reference to FIG. 6, an inductive battery charger assembly 60″ is presented with the charger 22″ as a wall-mounted hanger, wherein the service tool 10 is held within a suspension device 70 having a hook 72 such that the suspension device 70 holds the tool 10 against the charger 22″ so that the secondary coil 24 within the tool 10 contacts the primary coil 20 within the charger 22″.

Alternative embodiments of the inductive battery charger 22 are presented herein wherein the configurations of the primary coil 24 and its driving source of energy are varied, with the secondary coil 20 of the charging service tool 10 remaining substantially similar as described above. In one system, the primary coil 24 requires only AC power and a customary safety device (e.g. a fuse, circuit breaker, etc.). The secondary coil 20 contains a substantial amount of wire in order to step-down the primary coil voltage by a sufficient amount. The assembly requires larger coils with a greater number of turns and longer wire in order to achieve sufficient amounts of coupling efficiency. This assembly would require a larger recharging time, but will be minimally complex to construct.

A medium-current embodiment of the inductive battery charger assembly operates the primary coil 24 and the secondary coil 20 at a frequency higher than 60 Hz and selected to provide a tuned circuit between the coils. The combination of a higher frequency and tuning results in an increased efficiency in energy transfer. The service tool 10 and the base of the charger 22 may be substantially shielded to avoid excessive electromagnetic radiation. The higher energy transfer results in an increased current availability, which leads to a faster recharging rate.

To implement a high-efficiency embodiment of the inductive battery charger assembly, the tuned-transformer system of the previous a feedback embodiment can incorporate a feedback switch to turn off the primary coil 24 when the battery pack 56 is fully charged, or reduce the primary coil voltage or current substantially while maintaining a trickle charge. This provides a “green” or energy-saving system since the primary coil 24 does not provide maximum output when that output is not needed. The switching function is established by placing a magnetic reed switch outside of the main magnetic circuit and controlling the switch with a coil.

Although examples of power source of the primary coil 20B of the inductive battery charger are described with an AC or oscillator/DC driving voltage, it will be appreciated that another arrangement of two inductively-coupled coils may be implemented, wherein the coupling allows energy to be transferred across the separation between the two coils and used to charge the battery pack. Battery types other than NiMH and Li-Ion may also be used. Moreover, although the inductive battery charger assembly 10 is useful to for vehicle service markets it can also be used with other tools and/or in other industries. Alternative methods for inductively charging a battery through an electronic magnetic field, including wireless power transmission through magnetic loop antennas and other implementations known in the art may also be used in accordance with the embodiments described herein.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An inductive battery charging system for a handheld service tool, comprising:
a battery charger, coupled to a power source, including a primary coil enclosed within a housing; and
a handheld service tool, including:
a secondary coil to provide at least 100 mA of alternating current when inductively-coupled to the primary coil;
a rectifier coupled to the secondary coil;
a linear voltage regulator coupled to the rectifier;
a battery charge controller coupled to the linear voltage regulator;
a battery coupled to the battery charge controller; and
a housing to enclose at least the secondary coil, the rectifier, the voltage regulator, and the battery charge controller.

2. The charging system of claim 1, further comprising a base station having a platform upon which the battery charger is disposed.

3. The charging system of claim 1, wherein the battery charger is a wall-mounted plate including an attached cradle for storing the handheld device.

4. The charging system of claim 1, wherein the battery charger is a wall-mounted hanger with a hooked suspension unit.

5. The charging system of claim 1, wherein the power source is an AC power line or a DC power supply.

6. The charging system of claim 1, wherein the inductively-generated alternating current has a frequency greater than 60 Hz.

7. The charging system of claim 1, wherein the battery charger includes a feedback switch to turn off the primary coil after the battery is substantially charged.

8. The charging system of claim 1, wherein the battery charger includes a feedback switch to reduce the primary coil output to maintain a trickle charge after the battery is substantially charged.

9. The charging system of claim 1, wherein the system is hermetically sealed.

10. An inductively-charged, handheld service tool, comprising:
a coil to provide at least 100 mA of inductively-generated alternating current;
a rectifier coupled to the coil;
a linear voltage regulator coupled to the rectifier;
a battery charge controller, coupled to the linear voltage regulator; and
a battery coupled to the battery charge controller; and
a housing to enclose at least the coil, the rectifier, the voltage regulator and the battery charge controller.

11. The service tool of claim 10, wherein the inductively-generated alternating current has a frequency greater than 60 Hz.

12. The service tool of claim 10, further comprising a charge status indicator.

13. The service tool of claim 11, wherein the charge status indicator is at least one light emitting diode.

14. The service tool of claim 10, wherein the housing is hermetically sealed.

15. A method of inductively charging a handheld service tool, comprising:
placing a handheld service tool on a base station that includes a battery charger having a primary coil enclosed therein;
inductively coupling the output of the primary coil to a secondary coil, enclosed within the handheld service tool, to generate an AC waveform,
converting the AC waveform into a pulsating DC signal;
converting the pulsating DC voltage into a steady-state DC signal;
charging a battery of the handheld service tool using the steady state DC signal; and
indicating a charging status of the battery.

16. The method of claim 15, further comprising turning off the AC waveform after the battery is substantially charged.

17. The method of claim 15, further comprising reducing the magnitude of the AC waveform after the battery is substantially charged to maintain a trickle charge.

18. The method of claim 15, wherein the charging status is indicated by at least one light emitting diode.

19. An inductive battery charging system, comprising:
a battery charger, coupled to a power source, including means for generating an electromagnetic field enclosed therein; and
a handheld service tool, including:
means for inductively-coupling the electromagnetic field to provide at least 100 mA of alternating current;
means for charging a battery using the inductively-generated alternating current; and
means for housing at least the coupling means and the charging means.

20. The system of claim 18, wherein the handheld service tool includes means for indicating a charging status of the battery.
